(19) United States
(12) Patent Application Publication
(10) Pub. No.: US 2022/0114292 A1
(43) Pub. Date: Apr. 14, 2022

(54) Structure Analyzing Method, Device, and Non-Transitory Computer-Readable Medium Based on Equivalent Nodal Secant Mass Approximation

(71) Applicant: National Central University, Taoyuan City (TW)

(72) Inventors: TZU-YING LEE, Taoyuan City (TW); WEN-HSIAO HUNG, Taoyuan City (TW)

(73) Assignee: National Central University, Taoyuan City (TW)

(21) Appl. No.: 17/074,996

(22) Filed: Oct. 20, 2020

(30) Foreign Application Priority Data
Oct. 8, 2020 (TW) 109135024

(51) Int. Cl. G06F 30/13; G06F 30/23; G06T 17/20

(52) U.S. Cl. CPC G06F 30/13; G06F 2111/10; G06T 17/20; G06F 30/23

(57) ABSTRACT

The present invention relates to a structure analyzing method. The method includes dividing a physical structure into a plurality of virtual elements in accordance with a structural geometry of the physical structure and establishing a discrete increment secant iterative model including an equivalent nodal secant mass coefficient and an equivalent nodal secant mass damping coefficient; implementing an increment-secant iterative algorithm to repeatedly compute until convergence a secant mass coefficient slope corresponding to the equivalent nodal secant mass coefficient and a secant mass damping coefficient slope corresponding to the equivalent nodal secant mass damping coefficient; and replacing the equivalent nodal secant mass coefficient and the equivalent nodal secant mass damping coefficient by the converged secant mass coefficient slope and the converged secant mass damping coefficient slope respectively.

### CROSS-REFERENCE TO RELATED APPLICATION

This application claims priority benefit to Taiwan Invention Patent Application Serial No. 109135024, filed on Oct. 8, 2020, in Taiwan Intellectual Property Office, the entire disclosures of which are incorporated by reference herein.

### FIELD

The present invention relates to a structure analyzing method, device, and non-transitory computer-readable medium, in particular to a structure analyzing method, device, and non-transitory computer-readable medium that analyze and simulate a physical structure by using an increment-secant iterative algorithm based on equivalent nodal secant mass approximation.

### BACKGROUND

In the conventional technology, the non-linear dynamic history numerical analysis for various structures, such as mechanical metal components or reinforced concrete building structures, is implemented by implicit finite element analysis method (FEA), which is one of the most widely used numerical analysis tools in various fields such as academic research, solid mechanics field, fluid mechanics field, heat transfer field, manufacturing field and structural design fields, to perform nonlinear dynamic history numerical analysis for the structure.

Many commercial software commonly used in the industry, such as SAP2000 and ETABS, also use FEA as a standard numerical analysis tool, but the commercial software has many limitations and shortcomings, for example, when the commercial software analyzes a large and complex structures and performs the nonlinear dynamic history analysis, numerical divergence often occurs to make the analysis not be completed successfully, or the analysis time is too long. The limited-element software such as LS-DYNA, ABAQUS and OpenSees often used in academia has the functions more complete than that of SAP2000 and ETABS, but also has the drawbacks of numerical divergence or too long analysis time, and the above-mentioned software is not easy to simulate the discontinuous damaged structure.

In order to maintain the non-coupling characteristics of the equations of motion to control the equation to form diagonal matrix and avoid the calculation of inverse matrix after the equation is discretized, the numerical calculation process of the common software such as LS-DYNA and ABAQUS-Explicit usually omits the stiffness-proportional damping and only considers mass-proportional damping, so that it impossible to eliminate the high frequency response generated by the numerical model. The high frequency response is not real and often affects the accuracy of the analysis results.

In general, the conventional FEA numerical analysis or simulation, has two major drawbacks. The first drawback is the operation of the inverse matrix. The operation of the inverse matrix often causes many problems, such as numerical divergence, excessively long computation time, poor computation performance, and not easy to apply to the large complex structure analysis, discontinuous structure analysis or structural damaged simulation. The second drawback is that the conventional FEA numerical analysis or simulation and various commercial software only apply the lumped mass to calculate the mass matrix in the analysis of large and complex structure.

The mass matrix of the structure is usually calculated by two methods, the first method is the lumped mass and the second method is consistent mass. The lumped mass is to lump the masses of the elements to the ends of the elements, to make the mass matrix form a diagonal matrix, so there is no need to solve the inverse matrix. The consistent mass establishes the mass matrix according to the shape and geometry function of the structure, and the formed mass matrix approximates to the real situation and maintains a highly-coupling with the stiffness matrix, and the mass matrix established according to the consistent mass is unable to be diagonalized, so the inverse matrix must be solved.

Therefore, the conventional FEA numerical analysis or simulation and the various commercial software still has numerical divergence and is unable to successfully complete the analysis or takes too-long analysis time in the situation where the consistent mass must be used and the computation of the inverse matrix must be performed. Therefore, when analyzing large complex structures, discontinuous structures or damaged structures, the existing commercial software can be said to be helpless.

Hence, there is a need to solve the above deficiencies/issues.

### SUMMARY

In order to well solve the drawbacks in the conventional technology, the present invention proposes to apply the equivalent nodal secant mass and the mass damping coefficient into the discrete control equation based on the implicit structural dynamic finite element analysis which can be unconditionally stable, so that the dynamic equation is fully decoupled. In addition, the numerical simulation can be performed with the consistent mass assumption. The calculation process does not need to establish the mass matrix and the mass-proportional damping matrix, only the nodal internal structural forces and nodal damping of the element are calculated. Furthermore, any implicit direct integration method cooperated with the increment-secant iterative algorithm can converge in every iterative step, so as to take a larger step to greatly improve the calculation efficiency.

Under the conditions of obtaining the same precision solution, the calculation efficiency according to the present invention is much higher than that of the explicit central differential method. According to the results of the numerical verification, the convergence rate according to the present invention is equivalent to that of the iterative procedure of the conventional quasi-Newton method, the stability and accuracy of the numerical solution according to the present invention are equivalent to that of the conventional implicit direct integration method. Because there is no need to establish the mass matrix, any form of finite elements and damping elements can be directly added to the analysis program according to the present invention, so the present invention can be widely used to analyze various nonlinear and discontinuous cases.

Accordingly, the present invention provides a structure analyzing method which includes dividing a physical structure into a plurality of virtual elements in accordance with a structural geometry of the physical structure and establishing a discrete increment secant iterative model including an equivalent nodal secant mass coefficient and an equivalent nodal secant mass damping coefficient; implementing an increment-secant iterative algorithm to repeatedly compute until convergence a secant mass coefficient slope corresponding to the equivalent nodal secant mass coefficient and a secant mass damping coefficient slope corresponding to the equivalent nodal secant mass damping coefficient; and replacing the equivalent nodal secant mass coefficient and the equivalent nodal secant mass damping coefficient by the converged secant mass coefficient slope and the converged secant mass damping coefficient slope respectively.

The present invention further provides a non-transitory computer-readable medium that stores a program causing a computer to execute a process including dividing a physical structure into a plurality of virtual elements in accordance with a structural geometry of the physical structure and establishing a discrete increment secant iterative model including an equivalent nodal secant mass coefficient and an equivalent nodal secant mass damping coefficient; implementing an increment-secant iterative algorithm to repeatedly compute until convergence a secant mass coefficient slope corresponding to the equivalent nodal secant mass coefficient and a secant mass damping coefficient slope corresponding to the equivalent nodal secant mass damping coefficient; and replacing the equivalent nodal secant mass coefficient and the equivalent nodal secant mass damping coefficient by the converged secant mass coefficient slope and the converged secant mass damping coefficient slope respectively.

The present invention further provides a structure analyzing device that is characterized in that a hardware processor is configured to implement a process including dividing a physical structure into a plurality of virtual elements in accordance with a structural geometry of the physical structure and establishing a discrete increment secant iterative model including an equivalent nodal secant mass coefficient and an equivalent nodal secant mass damping coefficient; implementing an increment-secant iterative algorithm to repeatedly compute until convergence a secant mass coefficient slope corresponding to the equivalent nodal secant mass coefficient and a secant mass damping coefficient slope corresponding to the equivalent nodal secant mass damping coefficient; and replacing the equivalent nodal secant mass coefficient and the equivalent nodal secant mass damping coefficient by the converged secant mass coefficient slope and the converged secant mass damping coefficient slope respectively.

The above content described in the summary is intended to provide a simplified summary for the presently disclosed invention, so that readers are able to have an initial and basic understanding to the presently disclosed invention. The above content is not aimed to reveal or disclose a comprehensive and detailed description for the present invention, and is never intended to indicate essential elements in various embodiments in the present invention, or define the scope or coverage in the present invention.

### DESCRIPTION OF THE DRAWINGS

A more complete appreciation of the invention and many of the attendant advantages thereof are readily obtained as the same become better understood by reference to the following detailed description when considered in connection with the accompanying drawing, wherein:

FIG. 1 is a schematic diagram illustrating the structure analysis device according to the present invention;

FIG. 2 is a schematic diagram illustrating the structure model concerning the reinforced concrete column to be analyzed in the first and second embodiments according to the present invention;

FIG. 3 is a time-varying diagram illustrating the displacement with respect to time of the reinforced concrete column in the first embodiment without considering the proportional damping according to the present invention;

FIG. 4 is a time-varying diagram illustrating the base shear with respect to time of the reinforced concrete column in the first embodiment without considering the proportional damping according to the present invention;

FIG. 5 is a time-varying diagram illustrating the displacement with respect to time of the reinforced concrete column under the condition of applying 5% damping ratio in the second embodiment according to the present invention;

FIG. 6 is a time-varying diagram illustrating the base shear with respect to time of the reinforced concrete column under the condition of applying 5% damping ratio in the second embodiment according to the present invention;

FIG. 7 is a schematic diagram illustrating the truss model in which the rigid pendulum is hinged with the analyzed object in the third embodiment according to the present invention;

FIG. 8 is a schematic diagram illustrating the motion trajectory of the analyzed object hinged with the rigid pendulum in the third embodiment according to the present invention;

FIG. 9 is a time-varying diagram illustrating the displacement with respect to time of the rigid pendulum simulated in the third embodiment according to the present invention;

FIG. 10 is a time-varying diagram illustrating the velocity with respect to time of the rigid pendulum simulated in the third embodiment according to the present invention;

FIG. 11 is a time-varying diagram illustrating the acceleration with respect to time of the rigid pendulum simulated in the third embodiment according to the present invention;

FIG. 12 is a schematic diagram illustrating the structural model of the nine-story building with three-dimensional space flexural frame elements of the analyzed object in the fourth embodiment according to the present invention;

FIGS. 13 to 15 are acceleration time-history diagrams illustrating the input seismic wave with respect to time in the east-west, north-south and vertical directions in the fourth embodiment according to the present invention, respectively;

FIGS. 16 to 18 are time-history diagrams illustrating the displacement with respect to time of the three-dimensional space frame elements of the calculation object in the east-west, north-south and vertical directions in the fourth embodiment according to the present invention, respectively; and

FIG. 19 is a flow chart illustrating the structure analyzing method in accordance with the present invention.

### DETAILED DESCRIPTION

The present disclosure will be described with respect to particular embodiments and with reference to certain drawings, but the disclosure is not limited thereto but is only limited by the claims. The drawings described are only schematic and are non-limiting. In the drawings, the size of some of the elements may be exaggerated and not drawn on scale for illustrative purposes. The dimensions and the relative dimensions do not necessarily correspond to actual reductions to practice.

It is to be noticed that the term “including”, used in the claims, should not be interpreted as being restricted to the means listed thereafter; it does not exclude other elements or steps. It is thus to be interpreted as specifying the presence of the stated features, integers, steps or components as referred to, but does not preclude the presence or addition of one or more other features, integers, steps or components, or groups thereof. Thus, the scope of the expression “a device including means A and B” should not be limited to devices consisting only of components A and B.

The disclosure will now be described by a detailed description of several embodiments. It is clear that other embodiments can be configured according to the knowledge of persons skilled in the art without departing from the true technical teaching of the present disclosure, the claimed disclosure being limited only by the terms of the appended claims.

The present invention proposes a structure analyzing method and a computer program product thereof combining the increment-secant iterative algorithm, the implicit direct integration method, and the finite element analysis method (FEA). The structure analyzing method according to the present invention is able to discretize and decouple the dynamic control equation of the real non-linear structure, and diagonalize all matrices in the calculation process, and process the mass distribution according to the actual geometry of the nonlinear structure, for example, the mass distribution includes the differential term, such as: inertial term or damping term, related to the mass term in the structural dynamic equation; therefore, the mass distribution can highly consistent with the shape of the structure during the numerical dynamic simulation according to the present invention.

For nonlinear structures or discontinuous structures, such as but not limited to, metal sheets, metal rods, mechanism bodies, mechanical components, longitudinal beams, horizontal beams, reinforced concrete building structures such as discontinuous yielded structure, a discontinuous collapsed structure, a discontinuous cracked structure, a discontinuous damaged structure, a discontinuous fallen structure, a discontinuous failed structure, or a discontinuous separated structure, it is better to establish the structural dynamic discrete balance equation by the virtual displacement method as follows:

F_{I}(t)+F_{D}(t)+F_{D}(t)=R(t) (1)

The F_{I}(t), F_{D}(t), F_{S}(t) are equivalent nodal inertia of the element, equivalent nodal damping of the element, and equivalent nodal internal structural forces of the element, respectively. The R(t) is the equivalent loads applied on the node.

Under the assumption that the mass does not change over time and in consideration with assumptions of the structural geometry, the nonlinear material, and the proportional damping, based on the implicit direct integration and FEA, and based on the actual structural geometry, structural configuration, the structural type of the nonlinear structure, the physical structure of the nonlinear structure is transformed and divided into a plurality of virtual elements, the equation (1) is discretized in temporal and spatial, and the discrete increment iterative motion equation of the equation (1) at time-step t+Δt is expressed as follows:

$${M}^{t + Δ t} {\ddot{U}}^{( r )} + {a}_{0} {M}^{t + Δ t} {\dot{U}}^{( r )} + {a}_{1} {K}_{I} Δ {\dot{U}}^{( r )} + {}_{}^{t + Δ t}{K}{}_{T}^{( r - 1 )} Δ {U}^{( r )} = {}^{t + Δ t} R - {}_{}^{t + Δ t}{F}{}_{I}^{( r - 1 )} - {}_{}^{t + Δ t}{F}{}_{m D}^{( r - 1 )} - {}_{}^{t + Δ t}{F}{}_{k D}^{( r - 1 )} - {}_{}^{t + Δ t}{F}{}_{S}^{( r - 1 )} \qquad ( 2 )$$

The ^{t+Δt}Ü(t) and ^{t+Δt}\dot{U}(t) are the nodal acceleration and nodal velocity vector, respectively; M is the mass matrix, the a₀M is the proportional mass damping coefficient, and a1KI is the proportional stiffness damping coefficient, the K_{I} is the initial stiffness matrix of the structure, the a₀ and a₁ are constants, the ^{t+Δt}F_{mD} is the nodal mass-proportional damping generated by the mass-proportional damping a₀M^{t+Δt}\dot{U}, and ^{t+Δt}F_{kD} is the nodal damping generated by the stiffness-proportional damping a₁K_{I}^{t+Δt}\dot{U}, (r) represents the r^{th} iterative step, the (r−1) represents the (r−1)^{th} iterative step, the M is the mass matrix, ^{t+Δt}K_{T}^{(r-1)} is the tangent stiffness matrix after the (r−1)^{th} iterative step, the R is the applied load vector, the ^{t+Δt}F_{S}^{(r-1)} is the nodal internal structural forces vector of the element, the U and U are the nodal acceleration vector and the nodal velocity vector, respectively, and the ΔU^{(r)} is the increment for displacement vector at the r^{th} iterative step.

Furthermore, the concept of equivalent node secant is applied to derive the equivalent nodal secant mass coefficient, the equivalent nodal secant mass damping coefficient, the equivalent nodal secant damping coefficient, and the equivalent nodal secant stiffness coefficient of the equation (2), and decouple the equation (2). The discrete increment secant iterative dynamic balance equation of the equation (2) at time t+Δt, the r^{th} iterative step and the i^{th} degree of freedom (DOF) in the increment iterative process is expressed as following equation (3):

^{t+Δt}(\tilde{M}_{sec})ᵢ^{(r-1)}ΔÜᵢ^{(r)}+^{t+Δt}(\tilde{C}_{m_sec})ᵢ^{(r-1)}Δ\dot{U}ᵢ^{(r)}+^{t+Δt}(\tilde{C}_{k_sec})ᵢ^{(r-1)}Δ\dot{U}ᵢ^{(r)}+^{t+Δt}(\tilde{K}_{sec})ᵢ^{(r-1)}ΔUᵢ^{(r)}=^{t+Δt}Rᵢ−^{t+Δt}(F_{I})ᵢ^{(r-1)}−^{t+Δt}(F_{mD})ᵢ^{(r-1)}−^{t+Δt}(F_{kD})ᵢ^{(r-1)}−^{t+Δt}(F_{S})ᵢ^{(r-1)} (i=1, . . . ,n) (3)

The ΔÜᵢ^{(r)}ᵢ, Δ\dot{U}ᵢ^{(r)} and ΔUᵢ^{(r)} are the acceleration, velocity, and displacement increment at the rth iterative step, respectively, n is the number of DOFs in the structure system, and ^{t+Δt}(F_{kD})ᵢ^{(r-1)} is the nodal damping vector of the element at the previous iterative step in consideration with the stiffness damping a₁K_{I}, and ^{t+Δt}(F_{kD})ᵢ^{(r-1)} is the nodal internal structural force vector of the element at the previous iterative step.

The ^{t+Δt}(\tilde{M}_{sec})ᵢ^{(r-1)} and ^{t+Δt}(\tilde{C}_{m_sec})ᵢ^{(r-1)} are the equivalent nodal secant mass and the mass damping coefficient in the i^{th} direction of DOF at the (r−1)^{th} iterative step, respectively; the ^{t+Δt}(\tilde{C}_{sec})ᵢ^{(r-1)} and ^{t+Δt}(\tilde{K}_{sec})ᵢ^{(r-1)} are the equivalent nodal secant damping coefficient and equivalent nodal secant stiffness coefficient in the i^{th} direction of the DOF at the (r−1)^{th} iterative step, respectively. These coefficients are defined and computed based on the following equations (4) to (7):

^{t+Δt}(\tilde{M}_{sec})ᵢ^{(r-1)}ΔÜᵢ^{(r-1)}≡Δ^{t+Δt}(F_{I})ᵢ^{(r-1)} (4)

^{t+Δt}(\tilde{C}_{m_sec})ᵢ^{(r-1)}Δ\dot{U}ᵢ^{(r-1)}≡Δ^{t+Δt}(F_{mD})ᵢ^{(r-1)} (5)

^{t+Δt}(\tilde{C}_{m_sec})ᵢ^{(r-1)}Δ\dot{U}ᵢ^{(r-1)}≡Δ^{t+Δt}(F_{mD})ᵢ^{(r-1)} (6)

^{t+Δt}(\tilde{K}_{sec})ᵢ^{(r-1)}ΔUᵢ^{(r-1)}≡Δ^{t+Δt}(F_{S})ᵢ^{(r-1)} (7)

The Δ^{t+Δt}(F_{I})ᵢ^{(r-1)} and Δ^{t+Δt}(F_{mD})ᵢ^{(r-1)} are the increment for inertia term and increment for mass damping term at the previous iterative step, respectively; the Δ^{t+Δt}(F_{kD})ᵢ^{(r-1)} and Δ^{t+Δt}(F_{S})ᵢ^{(r-1)} are the increment for stiffness damping and the increment for the nodal internal force of the element at the previous iterative step, respectively.

The present invention proposes to apply the increment-secant iterative algorithm to approximate the equivalent nodal secant mass coefficient ^{t+Δt}(\tilde{M}_{sec})ᵢ^{(r-1)}, the equivalent nodal secant mass damping coefficient ^{t+Δt}(\tilde{C}_{m_sec})ᵢ^{(r-1)}, the equivalent nodal secant damping coefficient ^{t+Δt}(Ć_{sec})ᵢ^{(r-1)}, and the equivalent nodal secant stiffness coefficient ^{t+Δt}(\tilde{K}_{sec})ᵢ^{(r-1)} of the equations (4) to (7) at the previous iterative step, and replace the coefficient at the rth iterative step by the converged coefficients at the previous iterative step, that is, the (r−1)th iterative step, so as to cleverly avoid the problem of computation demanding and divergence of the conventional finite element analysis in computation of the large-sized inverse matrix during the process of solving the equation (3).

The method proposed by the present invention can use any implicit direct integration to solve, and when the increment-secant iterative algorithm is applied, the FEA calculation process does not need to establish the mass matrix M, the mass damping matrix a₀M, the stiffness matrix K and the damping matrix C, and also does not need to calculate the corresponding inverse matrix, and just need to compute the nodal internal structural forces and damping of the element, and any form of finite elements and damping elements can be directly added to the analysis program according to the present invention, so the structure analyzing method according to the present invention can be widely used to analyze various nonlinear and discontinuous problems, especially for the discontinuous structure, for example, calculation and simulation of yielded material, calculation and simulation of damaged and cracked structure and calculation and simulation of discontinuous structure.

For example, the direct integration can be selected from one of an implicit Newmark integration method, a Hilber-Hughes-Taylor-α implicit integration method (HHT-α), and a Bathe composite implicit integration method. For example, the increment secant iterative algorithm can be selected from one of a Newton method, a quasi-Newton method, a Newton-Raphson method, and a secant approximation method.

The method proposed by the present invention adopts the consistent mass assumption or the method consistent to the consistent mass assumption, to compute the inertial term and the damping term of individual element through the increment secant iteration, so as to easily solve the problem that the conventional numerical analysis or simulation for the nonlinear structure is unable to apply the consistent mass assumption. Furthermore, the computation process of the method according to the present invention does not need to solve the inverse matrix and is able to overcome the problem that the conventional explicit integration is unable to effectively process the inverse matrix.

The calculation program according to the present invention is suitable for numerical analysis and simulation of discontinuous nonlinear structures, and can also be applied to develop various finite elements, such as special support elements (variable-frequency support), special damping elements (variable stiffness damping) for new structural control elements, and these elements can be easily and quickly added to this calculation program according to the present invention.

The present invention proposes the concept of the equivalent nodal secant mass and mass damping coefficient to the implicit structural dynamic finite element calculation program. When the method according to the present invention is used for time-history analysis, there is no need to establish the mass matrix, the mass-proportional damping matrix, the stiffness matrix, the damping matrix, and also do not need to solve the inverse matrix. Furthermore, any implicit direct integration method cooperated with the increment-secant-iteration procedure can make each iterative step reach the convergence condition. Furthermore, the nodal internal structural force, nodal damping, nodal mass-proportional damping, and nodal inertia can be calculated in each element, so any kind of element can be easily added to the analysis method according to the present invention.

The structure analyzing method proposed by the present invention does not need to solve the inverse matrix, and uses the equivalent nodal secant coefficients to approximate the real solution instead, so the structure analyzing method according to the present invention is very suitable for analysis of the discontinuous nonlinear structure, for example, simulation or analysis of the yielded structure. In the following embodiments according to the present invention, the actual occurrence of the bridge collapses due to earthquake damage, that is, the problem of collapsed bridge under multiple-support excitation (MSE) is taken as an example to illustrate the powerful performance of the structure analysis method according to the present invention in simulating and analyzing discontinuous nonlinear structures.

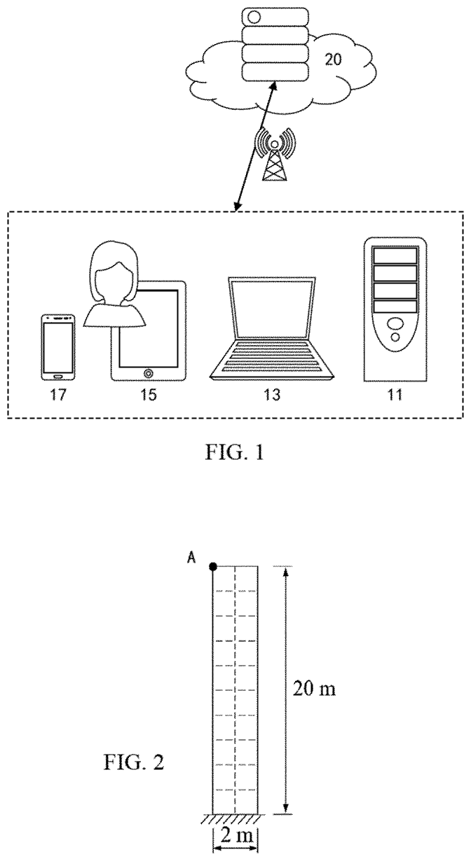

FIG. 1 is a schematic diagram illustrating the structure analysis device according to the present invention. The implementation of the structure analyzing method proposed by the present invention is specifically to program the structure analysis logic unit according to the present invention as the computer program product, the mobile application (App) or computer software, and the computer program product, the mobile application (App) or the computer software is loaded and executed by the processor of the computer. The computer program product, mobile application or computer software referred to in the present invention means the object carrying the computer-readable program and with unlimited external forms. After being loaded with the computer program product according to the present invention, the computer device becomes the structure analysis device according to the present invention. For example, as shown in FIG. 1, when the desktop computer 11, notebook computer 13, the tablet device 15, the smart phone 17 or any mobile device is loaded with the computer-readable program product containing the structure analyzing method according to the present invention, the device becomes the structure analysis device according to the present invention.

Preferably, the structure analysis device according to the present invention can be any computing device. When the processor of any computing device is loaded with the computer-readable program product containing the structure analyzing method according to the present invention, the computing device becomes the structure analysis device proposed by the present invention. The computing device can be a special purpose device, which is specially made to implement the structure analysis method according to the present invention. The computing device may have or may not have an input component. The computing device may or may not have an output interface.

Furthermore, with advancement and popularization of computer technology and network technology, the computer program product proposed by the present invention can be stored in recording medium or on a remote server 20, so that the computer software and computer program product containing the method according to the present invention can be directly provided for the user to operate through websites, webpages, instant messaging (IM), ChatBots on IM, user interface (UI) or web browser by using the platform as a service (PaaS), the software as a service (SaaS) and other technologies. Therefore, the computer program product carrying the method according to the present invention is not limited to use on a computer with recording media, and also can be provided to users through the Internet.

The present invention uses the nonlinear dynamic analysis of the reinforced concrete column as the first and second embodiments to illustrate the nonlinear structure analysis method according to the present invention. The first and second embodiments both apply the consistent mass in the mass processing, and use the implicit HHT-α integration as the increment secant iteration, and the calculation result according to the present invention is compared and verified with that of the existing commercial finite element analysis software ABAQUS. The first and second embodiments are to test the capability and convergence of the structure analyzing method and computer program product according to the present invention in processing the nonlinear dynamic problem. Because of being based on dynamics, the structure analyzing method according to the present invention can be more intuitively applied to the excitation analysis of solid.

FIG. 2 is a schematic diagram illustrating the structure model concerning the reinforced concrete column to be analyzed in the first and second embodiments according to the present invention. As shown in FIG. 2, the reinforced concrete column has a column with a height of 20 meters, a length of 2 meters, a width of 4 meters, and unit volume weight of 2.4 ft/m3, and the value E≈232379 kgf/cm² of the Young's modulus taken when the compressive strength f_{c}′ of concrete is 240 kgf/cm², and the Bersson's ratio v=0.15 in consideration with the plane stress state. The displacement check point is the horizontal displacement response of the node A in FIG. 2, and the inputted surface acceleration is the north-south record of the Japan Meteorological Agency (JMA) Kobe Station for the Great Hanshin Earthquake. In order to make the high frequency vibration of the structure obvious, the earthquake magnification is magnified to 2 times.

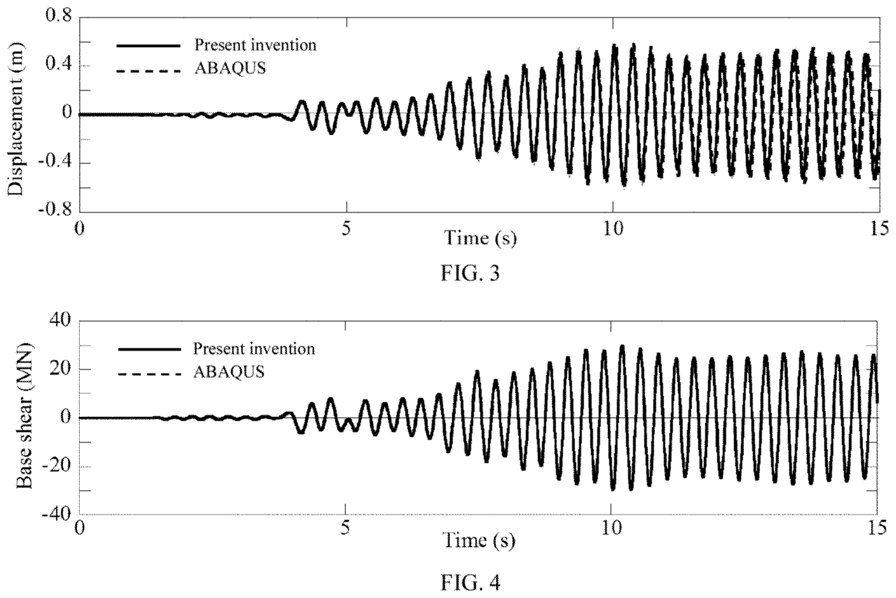

FIG. 3 is a time-varying diagram illustrating the displacement with respect to time of the reinforced concrete column in the first embodiment without considering the proportional damping according to the present invention. FIG. 4 is a time-varying diagram illustrating the base shear with respect to time of the reinforced concrete column in the first embodiment without considering the proportional damping according to the present invention. FIGS. 3 and 4 are time-varying diagram of the displacement response time-history data computed by the method according to the present invention without damping. In general, the most of static problems belong to low-frequency oscillations and can be effectively dissipated by the mass-proportional damping. In this embodiment, the reinforced concrete column is divided into 20 pieces of four-node elements, as shown in FIGS. 3 and 4, when the seismic wave exceeds the peak ground acceleration (PGA) thereof, the structure produces high-frequency oscillations, and the oscillation continues and cannot be dissipated. As shown in FIGS. 3 and 4, the calculation result according to the present invention in this case is shown as a solid line, and the calculation result of the commercial software ABAQUS is shown as a dashed line, and the solid line and the dashed line highly coincide, and it verifies and demonstrates the correctness and feasibility of the method according to the present invention.

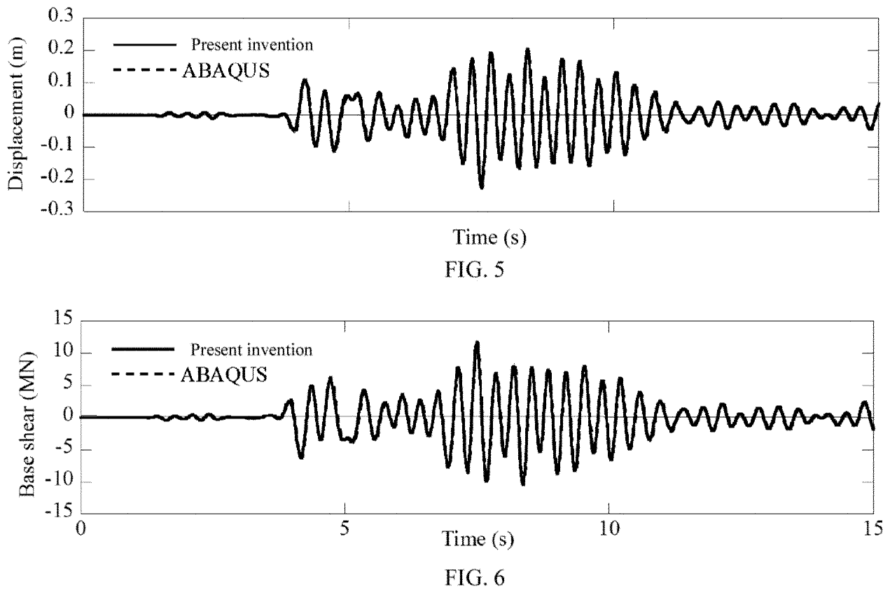

FIG. 5 is a time-varying diagram illustrating the displacement with respect to time of the reinforced concrete column under the condition of applying 5% damping ratio in the second embodiment according to the present invention. FIG. 6 is a time-varying diagram illustrating the base shear with respect to time of the reinforced concrete column under the condition of applying 5% damping ratio in the second embodiment according to the present invention. When a structure is shaken by an earthquake, the response of the structure produces a high-frequency oscillation because the seismic wave usually contains high-frequency energy, so the stiffness proportional damping must be applied to eliminate high frequency phenomenon of the building caused by the effect of the high-frequency oscillation when the mechanical analysis is performed, so as to match the physical phenomenon of nature.

In the second embodiment, the reinforced concrete column is divided into 20 pieces of four-node elements. The calculation parameters are given as the damping ratio of the first vibration state to the second vibration state being 5%, and the proportional damping coefficients a₀ and a₁ are calculated based on the damping ratio, and the analysis time step is set as Δt=10⁻⁴ s. As shown in FIGS. 5 and 6, the analysis results according to the present invention highly coincident with the analysis results of the ABAQUS, and it verifies that the method according to the present invention has accuracy in computation of a stiffness proportional damping and mass-proportional damping.

The third embodiment according to the present invention takes the nonlinear dynamic analysis of the rigid pendulum as an example for illustration. The third embodiment uses the equivalent secant mass coefficient to solve the consistent mass problem, and uses different implicit integrations to calculate the physical quantity of the node. The results of numerical calculation can prove the correctness and robustness of the method according to the present invention.

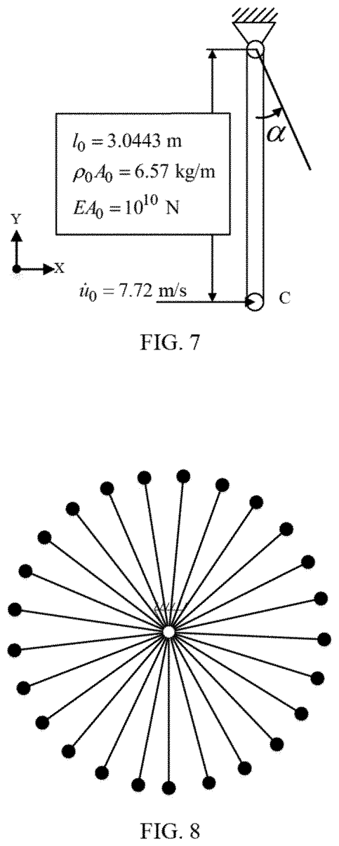

FIG. 7 is a schematic diagram illustrating the truss model in which the rigid pendulum is hinged with the analyzed object in the third embodiment according to the present invention. FIG. 8 is a schematic diagram illustrating the motion trajectory of the analyzed object hinged with the rigid pendulum in the third embodiment according to the present invention. The rigid pendulum shown in FIGS. 7 and 8 has a length l0 of 3.0443 m, and a unit volume weight ρ₀A₀ of 6.57 kg/m and the product EA0 of Young's modulus and the cross-sectional area is 10¹⁰ N, and the period is 2.4777 seconds, and the initial velocity \dot{u}₀ of the node C in the X direction is 7.72 m/s.

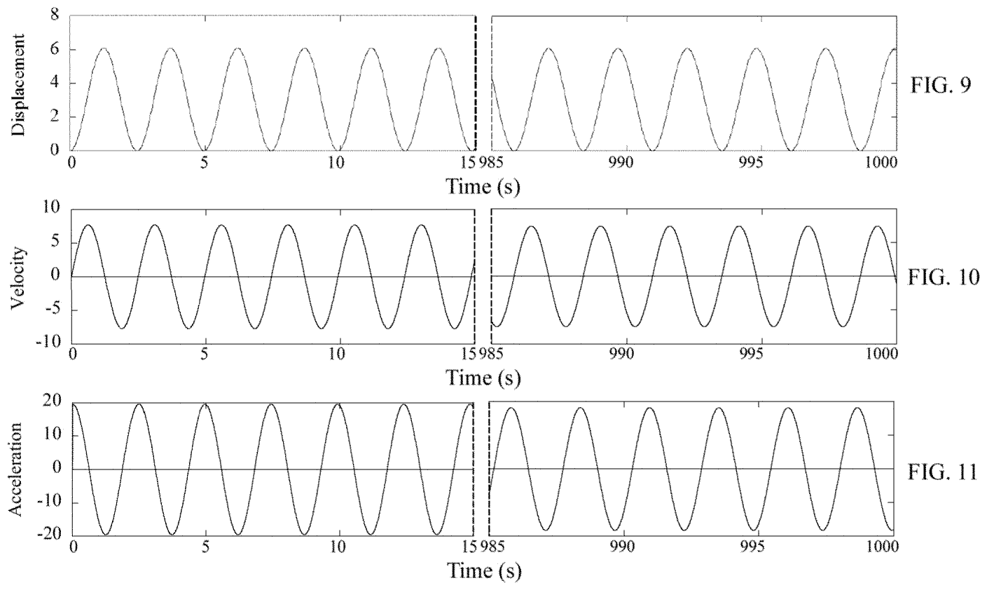

FIG. 9 is a time-varying diagram illustrating the displacement with respect to time of the rigid pendulum simulated in the third embodiment according to the present invention. FIG. 10 is a time-varying diagram illustrating the velocity with respect to time of the rigid pendulum simulated in the third embodiment according to the present invention. FIG. 11 is a time-varying diagram illustrating the acceleration with respect to time of the rigid pendulum simulated in the third embodiment according to the present invention. When the structure contains ultra-high stiffness elements or has high geometric nonlinearity, the Newmark average acceleration method may have problem in acceleration calculation, so the implicit integration is implemented by the Bathe complex integration method.

In this embodiment, the truss element is simulated by using the Bathe complex integration, and the time step is 0.01 seconds. After 400 periods, the calculation results of node C are shown in FIGS. 9 to 11, and the amplitude decay (AD) is about 0.0037%, and the period elongation (PE) is about 2.43%. The analysis results of multiple calculation examples show that the computation efficiency can be the highest when the time step is taken as 10⁻⁴ s, and this time step can also minimize AD and PE, for example, AD is 0.0029% and PE is almost zero, and the overall calculation and analysis results are also highly consistent with analytic solution.

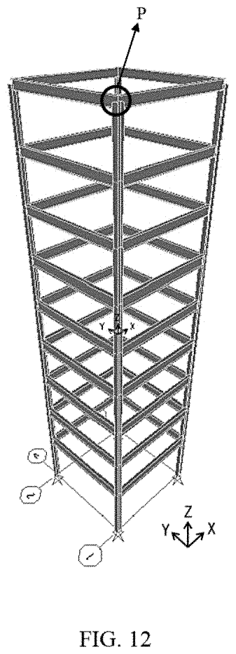

FIG. 12 is a schematic diagram illustrating the structural model of the nine-story building with three-dimensional space flexural frame elements of the analyzed object in the fourth embodiment according to the present invention. As shown in FIG. 12, the flexural frame model of the nine-story building is established with the three-dimensional frame elements to verify the accuracy and computational efficiency of the structure analysis method according to the present invention. In this example, the flexural steel frame structure design model of the nine-story building is established based on the steel structure design model provided in Annex B of FEMA-335C. The simplified model data parameters are disclosed in the following table, and the schematic diagram of the structure model is shown in FIG. 12.

| | Column section | | Beam Section | Mass of floor |
|---|---|---|---|---|
| Floor | (ASCI) | Floor | (ASCI) | (ton) |
| 1/2 | W14X370 | 2 | W36X160 | 34.98 |
| 2/3 | W14X370 | 3 | W36X160 | 34.29 |
| 3/4 | W14X370 | 4 | W36X135 | 34.29 |
| 4/5 | W14X283 | 5 | W36X135 | 34.29 |
| 5/6 | W14X283 | 6 | W36X135 | 34.29 |
| 6/7 | W14X257 | 7 | W36X135 | 34.29 |
| 7/8 | W14X257 | 8 | W30X99 | 34.29 |
| 8/9 | W14X233 | 9 | W27X84 | 34.29 |
| 9/Roof | W14X233 | Roof | W24X68 | 37.35 |

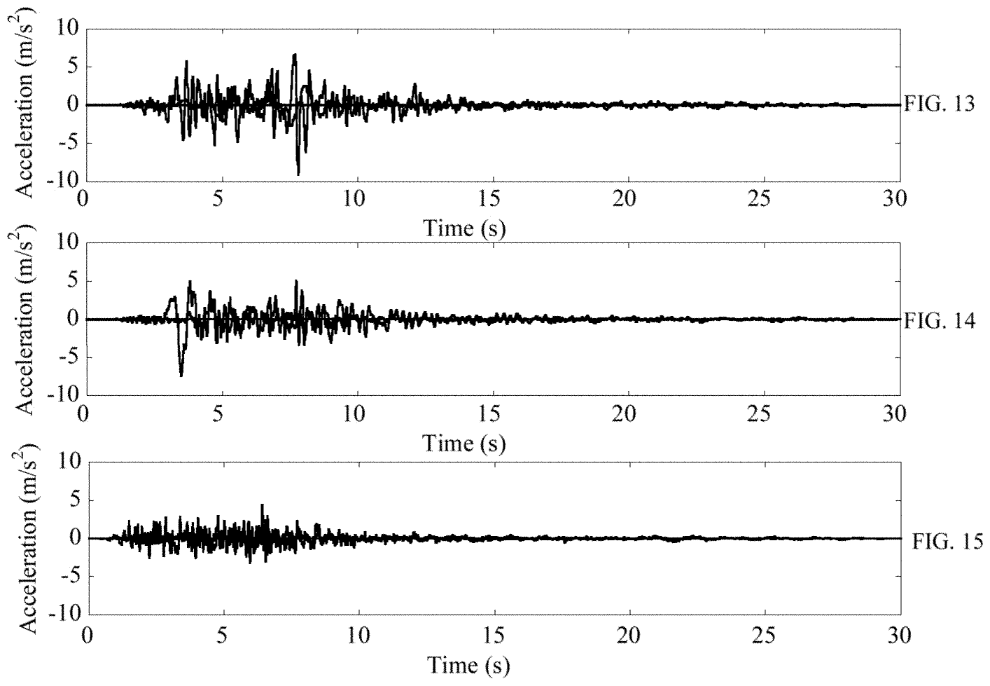

FIGS. 13 to 15 are acceleration time-history diagrams illustrating the input seismic wave with respect to time in the east-west, north-south and vertical directions in the fourth embodiment according to the present invention, respectively. In this example, the input seismic wave is measured in the Northridge earthquake in the United States in 1994, and FIGS. 13 to 15 shows the time-history of the acceleration of the seismic wave in the X direction (the east-west direction), the Y direction (the north-south direction), and the Z direction (the vertical direction), respectively. In order to clearly analyze the geometric nonlinear behavior of large deformations, this embodiment adjusts the input seismic wave to be five times of the original seismic wave. It is worth noting that this embodiment uses concentrated mass to establish masses of the nodes, but the rotational DOF inertia is affected by geometric nonlinearity, and the rotational DOF inertia and the mass-proportional damping of the node are coupled with each other, so this embodiment uses the equivalent nodal secant mass and the mass damping coefficient to process the rotational DOF Inertial force and mass-proportional damping.

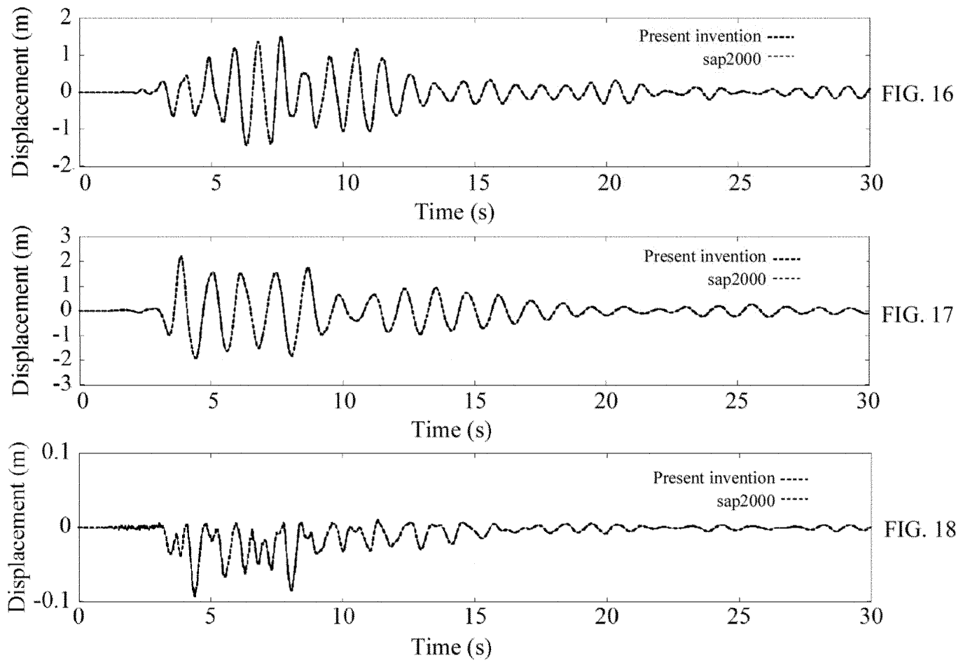

FIGS. 16 to 18 are time-history diagrams illustrating the displacement with respect to time of the three-dimensional space frame elements of the calculation object in the east-west, north-south and vertical directions in the fourth embodiment according to the present invention, respectively. This embodiment uses the commercial structural calculation software SAP2000 as the comparison reference, and performs the nonlinear dynamic history analysis under the same implicit integration method and calculation conditions as the SAP2000 and in condition with the proportional damping, so as to calculate and analyze the nonlinear dynamic history behavior of three-dimensional flexural frame elements of the nine-story building. The node P of FIG. 12 is taken as an example, the displacement time-history behavior computed and analyzed by the structure analysis method according to the present invention is shown in FIGS. 16 to 18.

According to FIGS. 16 to 18, the calculation results of the calculation method proposed by the present invention completely coincide with the calculation results of SAP2000, and it verifies the high accuracy according to the present invention. Furthermore, under the same analysis conditions, there is a big difference in the calculation times taken by the calculation method according to the present invention and the SAP2000 to obtain the same calculation results. The method according to the present invention only takes 21 seconds for calculation, and the SAP2000 takes 3112 seconds for calculation. Therefore, the present invention can perform calculation with accuracy and greatly-reduced calculation time; for example, compared with SAP2000, the method according to the present invention can save nearly one hundred or even two hundred times of the calculation time, and significantly improve the analysis and calculation efficiency.

According to the first to fourth embodiments, the implicit structural dynamic finite element computation program according to the present invention can easily process the above-mentioned highly nonlinear and discontinuous problems, and the features of stability, robustness and high efficiency according to the present invention can be extended to various engineering calculation fields to understand the failure sequence and collapse conditions of the designed structure reaching the limit state, and to verify whether the designed structure reaches the set performance target under different earthquake levels, and can also be used for structural seismic design verification to verify and confirm that the designed structure reaches the set performance target under different earthquake levels.

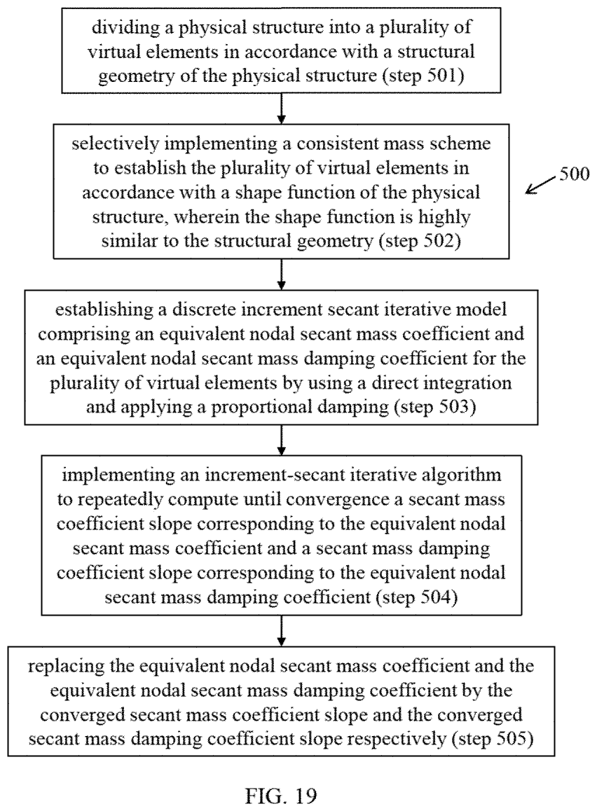

FIG. 19 is a flow chart illustrating the structure analyzing method in accordance with the present invention. To sum up, the structure analyzing method 500 in accordance with the present invention preferably includes the following steps: dividing a physical structure into a plurality of virtual elements in accordance with a structural geometry of the physical structure (step 501); selectively implementing a consistent mass scheme to establish the plurality of virtual elements in accordance with a shape function of the physical structure, wherein the shape function is highly similar to the structural geometry (step 502); establishing a discrete increment secant iterative model comprising an equivalent nodal secant mass coefficient and an equivalent nodal secant mass damping coefficient for the plurality of virtual elements by using a direct integration and applying a proportional damping (step 503); implementing an increment-secant iterative algorithm to repeatedly compute until convergence a secant mass coefficient slope corresponding to the equivalent nodal secant mass coefficient and a secant mass damping coefficient slope corresponding to the equivalent nodal secant mass damping coefficient (step 504); and replacing the equivalent nodal secant mass coefficient and the equivalent nodal secant mass damping coefficient by the converged secant mass coefficient slope and the converged secant mass damping coefficient slope respectively (step 505).

In summary, this finite element dynamic analysis program according to the present invention combines the advantages of the conventional explicit and implicit direct integrations without drawbacks thereof. Furthermore, the structural stiffness damping can be considered in the structural model, and it is especially suitable for the analysis of highly nonlinear and discontinuous large-scale structural dynamic systems. The structural model is robust and efficient, and especially suitable for the analysis of collapsed structures in earthquake disaster.

Compared with the conventional FEA software that is unable to simulate highly nonlinear and discontinuous damaged and collapsed structure, the structure analysis method according to the present invention allows free addition of multiple highly nonlinear analysis methods, for example, the multi-support seismic wave input function for simulating the slope slippage occurred on the single side of the structural objects, the collision element for simulating the collision of components, simulating the collision of the falling component and other component or even simulating the situation of the component falling to the ground, the nonlinear connection element for simulating the structural support behavior and damage, simulating the plastic hinge behavior and fracture of the component, and simulating the passive pressure of soil.

Compared with the conventional FEA dynamic analysis program, the structure analysis method according to the present invention has advantages of simplicity, stability, robustness and high efficiency, and can be used to simulate the destruction sequence and collapse of the structure at the limit status under extreme external force.

There are further embodiments provided as follows.

Embodiment 1: A structure analyzing method includes dividing a physical structure into a plurality of virtual elements in accordance with a structural geometry of the physical structure and establishing a discrete increment secant iterative model including an equivalent nodal secant mass coefficient and an equivalent nodal secant mass damping coefficient; implementing an increment-secant iterative algorithm to repeatedly compute until convergence a secant mass coefficient slope corresponding to the equivalent nodal secant mass coefficient and a secant mass damping coefficient slope corresponding to the equivalent nodal secant mass damping coefficient; and replacing the equivalent nodal secant mass coefficient and the equivalent nodal secant mass damping coefficient by the converged secant mass coefficient slope and the converged secant mass damping coefficient slope respectively.

Embodiment 2: The structure analyzing method as described in Embodiment 1, the process further includes implementing a consistent mass scheme to establish the plurality of virtual elements in accordance with a shape function of the physical structure, wherein the shape function is highly similar to the structural geometry; adding an equivalent nodal secant damping coefficient and an equivalent nodal secant stiffness coefficient into the discrete increment secant iterative model; establishing the discrete increment secant iterative model for the plurality of virtual elements by using a direct integration; selectively applying a proportional damping into the discrete increment secant iterative model to form a second discrete increment secant iterative model; selectively applying the equivalent nodal secant mass coefficient and the equivalent nodal secant mass damping coefficient at the previous iterative step into the second discrete increment secant iterative model to form a third discrete increment secant iterative model; and deriving equations for the equivalent nodal secant mass coefficient and the equivalent nodal secant mass damping coefficient from the third discrete increment secant iterative model.

Embodiment 3: The structure analyzing method as described in Embodiment 1, the equivalent nodal secant mass coefficient is defined by the equation as follow: ^{t+Δt}(\tilde{M}_{sec})ᵢ^{(r-1)}ΔÜᵢ^{(r-1)}≡Δ^{t+Δt}(F_{I})ᵢ^{(r-1)}, wherein ^{t+Δt}(\tilde{M}_{sec})ᵢ^{(r-1)} is the equivalent nodal secant mass coefficient at the previous iterative step, ΔÜᵢ^{(r-1)} is the acceleration at the previous iterative step, and ^{t+Δt}(F_{I})ᵢ^{(r-1)} is the increment for inertia term at the previous iterative step.

Embodiment 4: The structure analyzing method as described in Embodiment 1, the equivalent nodal secant mass damping coefficient is defined by the equation as follow: ^{t+Δt}(\tilde{M}_{sec})ᵢ^{(r-1)}Δ\dot{U}ᵢ^{(r-1)}≡Δ^{t+Δt}(F_{mD})ᵢ^{(r-1)}, wherein ^{t+Δt}(\tilde{C}_{m_sec})ᵢ^{(r-1)} is the equivalent nodal secant mass damping coefficient at the previous iterative step, Δ\dot{U}ᵢ^{(r-1)} is the velocity at the previous iterative step, and Δ^{t+Δt}(F_{mD})ᵢ^{(r-1)} is the increment for mass damping term at the previous iterative step.

Embodiment 5: The structure analyzing method as described in Embodiment 1, the increment secant iterative algorithm is selected from one of a Newton method, a quasi-Newton method, a Newton-Raphson method, and a secant approximation method.

Embodiment 6: The structure analyzing method as described in Embodiment 1, the direct integration is selected from one of an implicit Newmark integration method, a Hilber-Hughes-Taylor-a implicit integration method (HHT-a), and a Bathe composite implicit integration method.

Embodiment 7: The structure analyzing method as described in Embodiment 1, the physical structure is a discontinuous yielded structure, a discontinuous collapsed structure, a discontinuous cracked structure, a discontinuous damaged structure, a discontinuous fallen structure, a discontinuous failed structure, or a discontinuous separated structure.

Embodiment 8: A non-transitory computer-readable medium stores a program causing a computer to execute a process, and the process includes dividing a physical structure into a plurality of virtual elements in accordance with a structural geometry of the physical structure and establishing a discrete increment secant iterative model including an equivalent nodal secant mass coefficient and an equivalent nodal secant mass damping coefficient; implementing an increment-secant iterative algorithm to repeatedly compute until convergence a secant mass coefficient slope corresponding to the equivalent nodal secant mass coefficient and a secant mass damping coefficient slope corresponding to the equivalent nodal secant mass damping coefficient; and replacing the equivalent nodal secant mass coefficient and the equivalent nodal secant mass damping coefficient by the converged secant mass coefficient slope and the converged secant mass damping coefficient slope respectively.

Embodiment 9: The non-transitory computer-readable medium as described in Embodiment 8, the process further includes implementing a consistent mass scheme to establish the plurality of virtual elements in accordance with a shape function of the physical structure, wherein the shape function is highly similar to the structural geometry; adding an equivalent nodal secant damping coefficient and an equivalent nodal secant stiffness coefficient into the discrete increment secant iterative model; establishing the discrete increment secant iterative model for the plurality of virtual elements by using a direct integration; selectively applying a proportional damping into the discrete increment secant iterative model to form a second discrete increment secant iterative model; selectively applying the equivalent nodal secant mass coefficient and the equivalent nodal secant mass damping coefficient at the previous iterative step into the second discrete increment secant iterative model to form a third discrete increment secant iterative model; and deriving equations for the equivalent nodal secant mass coefficient and the equivalent nodal secant mass damping coefficient from the third discrete increment secant iterative model.

Embodiment 10: A structure analyzing device is characterized in that a hardware processor is configured to implement a process including dividing a physical structure into a plurality of virtual elements in accordance with a structural geometry of the physical structure and establishing a discrete increment secant iterative model including an equivalent nodal secant mass coefficient and an equivalent nodal secant mass damping coefficient; implementing an increment-secant iterative algorithm to repeatedly compute until convergence a secant mass coefficient slope corresponding to the equivalent nodal secant mass coefficient and a secant mass damping coefficient slope corresponding to the equivalent nodal secant mass damping coefficient; and replacing the equivalent nodal secant mass coefficient and the equivalent nodal secant mass damping coefficient by the converged secant mass coefficient slope and the converged secant mass damping coefficient slope respectively.

While the disclosure has been described in terms of what are presently considered to be the most practical and preferred embodiments, it is to be understood that the disclosure need not be limited to the disclosed embodiments. On the contrary, it is intended to cover various modifications and similar arrangements included within the spirit and scope of the appended claims, which are to be accorded with the broadest interpretation so as to encompass all such modifications and similar structures. Therefore, the above description and illustration should not be taken as limiting the scope of the present disclosure which is defined by the appended claims.

1. A computer-implemented structure analyzing method causing a computer to execute a computer-assisted simulation of a dynamic behavior of a physical structure in a real world, the method comprising:
pre-dividing a physical structure into a plurality of virtual elements in accordance with a structural geometry of the physical structure;
provided in a non-transitory computer-readable medium in the computer a discrete increment secant iterative model established in each of the plurality of virtual elements and introducing a mass term which is established based on a consistent mass scheme in each of plurality of virtual elements and capable of being further discretized into an incremental secant form to have an equivalent nodal secant mass coefficient and an equivalent nodal secant mass damping coefficient which the coefficients are capable of being processed by an iteration based scheme to avoid processing the mass term in a form of a mass matrix in order to avoid processing the inverse matrix of the mass matrix;
causing a processor coupled with the non-transitory computer-readable medium to:
implement an increment-secant iterative algorithm, which the algorithm processes the mass term by the iteration based scheme, to repeatedly compute until convergence a secant mass coefficient slope corresponding to the equivalent nodal secant mass coefficient and a secant mass damping coefficient slope corresponding to the equivalent nodal secant mass damping coefficient; and
replace the equivalent nodal secant mass coefficient and the equivalent nodal secant mass damping coefficient by the converged secant mass coefficient slope and the converged secant mass damping coefficient slope respectively to update the discrete increment secant iterative model; and
causing a display coupled with the processor to display a spatial and temporal variation of the plurality of virtual elements representing for the physical structure according to the updated discrete increment secant iterative model.

2. The structure analyzing method as claimed in claim 1, wherein the process further comprises:
implementing the consistent mass scheme to establish the plurality of virtual elements in accordance with a shape function of the physical structure;
adding an equivalent nodal secant damping coefficient and an equivalent nodal secant stiffness coefficient into the discrete increment secant iterative model;
establishing the discrete increment secant iterative model for the plurality of virtual elements by using a direct integration;
selectively applying a proportional damping into the discrete increment secant iterative model to form a second discrete increment secant iterative model;
selectively applying the equivalent nodal secant mass coefficient and the equivalent nodal secant mass damping coefficient at the previous iterative step into the second discrete increment secant iterative model to form a third discrete increment secant iterative model; and
deriving equations for the equivalent nodal secant mass coefficient and the equivalent nodal secant mass damping coefficient from the third discrete increment secant iterative model.

3. The structure analyzing method as claimed in claim 1, wherein the equivalent nodal secant mass coefficient is defined by the equation as follow: ^{t+Δt}(\tilde{M}_{sec})ᵢ^{(r-1)}ΔÜᵢ^{(r-1)}≡Δ^{t+Δt}(F_{I})ᵢ^{(r-1)}, wherein ^{t+Δt}(\tilde{M}_{sec})ᵢ^{(r-1)}, is the equivalent nodal secant mass coefficient at the previous iterative step, ΔÜᵢ^{(r-1)} is the acceleration at the previous iterative step, and Δ^{t+Δt}(F_{I})ᵢ^{(r-1)} is the increment for inertia term at the previous iterative step.

4. The structure analyzing method as claimed in claim 1, wherein the equivalent nodal secant mass damping coefficient is defined by the equation as follow: ^{t+Δt}(\tilde{C}_{m_sec})ᵢ^{(r-1)}Δ\dot{U}ᵢ^{(r-1)}≡Δ^{t+Δt}(F_{mD})ᵢ^{(r-1)}, wherein ^{t+Δt}(\tilde{C}_{m_sec})ᵢ^{(r-1)} is the equivalent nodal secant mass damping coefficient at the previous iterative step, Δ\dot{U}ᵢ^{(r-1)} is the velocity at the previous iterative step, and ^{t+Δt}(F_{mD})ᵢ^{(r-1)} is the increment for mass damping term at the previous iterative step.

5. The structure analyzing method as claimed in claim 1, wherein the increment secant iterative algorithm is selected from one of a Newton method, a quasi-Newton method, a Newton-Raphson method, and a secant approximation method.

6. The structure analyzing method as claimed in claim 1, wherein the direct integration is selected from one of an implicit Newmark integration method, a Hilber-Hughes-Taylor-a implicit integration method (HHT-α), and a Bathe composite implicit integration method.

7. The structure analyzing method as claimed in claim 1, wherein the physical structure is a discontinuous nonlinear structure, a discontinuous collapsed structure, a discontinuous cracked structure, a discontinuous damaged structure, a discontinuous fallen structure, a discontinuous failed structure, or a discontinuous separated structure.

8. (canceled)

9. (canceled)

10. A structure analyzing device, that the device comprises a hardware processor which is configured to implement a computer-implemented structure analyzing method to execute a computer-assisted simulation of a dynamic behavior of a physical structure in a real world, the method comprising:
pre-dividing a physical structure into a plurality of virtual elements in accordance with a structural geometry of the physical structure;
provided in a non-transitory computer-readable medium in the device a discrete increment secant iterative model established in each of the plurality of virtual elements and introducing a mass term which is established based on a consistent mass scheme in each of plurality of virtual elements and capable of being further discretized into an incremental secant form to have an equivalent nodal secant mass coefficient and an equivalent nodal secant mass damping coefficient which the coefficients are capable of being processed by an iteration based scheme to avoid processing the mass term in a form of mass matrix in order to avoid processing the inverse matrix of the mass matrix;
causing the hardware processor coupled with the non-transitory computer-readable medium to:
implement an increment-secant iterative algorithm, which the algorithm processes the mass term by the iteration based scheme, to repeatedly compute until convergence a secant mass coefficient slope corresponding to the equivalent nodal secant mass coefficient and a secant mass damping coefficient slope corresponding to the equivalent nodal secant mass damping coefficient; and
replace the equivalent nodal secant mass coefficient and the equivalent nodal secant mass damping coefficient by the converged secant mass coefficient slope and the converged secant mass damping coefficient slope respectively to update the discrete increment secant iterative model; and
causing a display coupled with the processor to display a spatial and temporal variation of the plurality of virtual elements representing for the physical structure according to the updated discrete increment secant iterative model.
